(19) United States
(12) Patent Application Publication
(10) Pub. No.: US 2024/0134956 A1
(43) Pub. Date: Apr. 25, 2024

(54) ACCESSORY SETUP USING A SETUP CODE

(71) Applicant: Apple Inc., Cupertino, CA (US)

(72) Inventors: Anshul JAIN, San Diego, CA (US); Patrick L. COFFMAN, San Francisco, CA (US); Andreas I. GAL, Portola Valley, CA (US); Jared S. GRUBB, Seattle, WA (US); Anush G. NADATHUR, San Jose, CA (US); Justin N. WOOD, Los Altos, CA (US)

(21) Appl. No.: 18/370,369

(22) Filed: Sep. 18, 2023

Related U.S. Application Data
(60) Provisional application No. 63/418,445, filed on Oct. 21, 2022.

(51) Int. Cl. G06F 21/44

(52) U.S. Cl. CPC G06F 21/44

(57) ABSTRACT

Some techniques are described herein for a setup component of a controller to add accessories to a new ecosystem (e.g., a grouping of one or more accessories and one or more controllers and/or a grouping of one or more accessories to an application) that are already added to another ecosystem. Such techniques can include the setup component maintaining a list of accessories for which the setup component has added to the other ecosystem. Using the list, the setup component adds the accessories in the list to the new ecosystem through communications with the accessories and an application corresponding to the new ecosystem.

### CROSS-REFERENCE TO RELATED APPLICATIONS

The present application claims benefit of U.S. Provisional Application Ser. No. 63/418,445, entitled “ACCESSORY SETUP USING A SETUP CODE” filed Oct. 21, 2022, which is hereby incorporated by reference in its entirety for all purposes.

### BACKGROUND

Electronic devices are becoming increasingly interconnected. For example, controllers (e.g., user devices and/or computer systems) are often connected to accessories (e.g., a speaker, a fan, and a thermostat) in the home or office. Setting tip such electronic devices has become more difficult as the configurations of those connections have become more complicated. Accordingly, there is a need to improve techniques for setting up different electronic devices.

### SUMMARY

Current techniques for setting up electronic devices (e.g., controllers, accessories, user devices, and/or computer systems) are generally ineffective and/or inefficient. For example, some techniques require users to open an application of an electronic device and set up a connection with a different electronic device through communications between the application and the different electronic device. This disclosure provides more effective and/or efficient techniques for setting tip electronic devices using examples of applications of a controller connecting with accessories. It should be recognized that other types of electronic devices can be used with techniques described herein. For example, a smartphone can connect with a laptop using techniques described herein. In addition, techniques optionally complement or replace other techniques for connecting electronic devices.

Some techniques are described herein for a setup component of a controller to add accessories to a new ecosystem (e.g., a grouping of one or more accessories and one or more controllers and/or a grouping of one or more accessories to an application). Such techniques include the setup component receiving a setup code for an accessory to be added to the new ecosystem. If a determination is made that the setup code has not previously established a credential with the accessory (e.g., that the accessory is not currently added to any ecosystem), the setup component sends a request to add a first credential, the request including the first setup code. However, if the determination is made that the setup code has previously established a credential with the accessory (e.g., that the accessory has already been added to another ecosystem using the setup code), the setup component sends a request to add another credential, the request including a setup code that is different from the setup code that was initially received by the setup component. In some examples, identifying that the setup code has been used already (e.g., used to establish a credential and/or add the accessory to an ecosystem) and initiating a process (e.g., sending the request) to establish a credential with a new setup code, enables a credential to be established with the accessory without the user having to identify a setup code that has not been previously used.

In some examples, a method is described that is performed at a setup component of a computer system. In some examples, the method comprises: receiving a first setup code for an accessory, wherein the accessory is different from the computer system; and in response to receiving the first setup code: in accordance with a determination that the setup component has not previously established a credential with the accessory, sending, to the accessory, a request to add a first credential to grant one or more first entitlements with respect to the accessory, wherein the request to establish the first credential includes the first setup code; and in accordance with a determination that the setup component has previously established a credential with the accessory, sending, to the accessory, a request to add a second credential to grant one or more second entitlements with respect to the accessory, wherein the second credential is different from the first credential, and wherein the request to add the second credential includes a second setup code that is different from the first setup code.

In some examples, a non-transitory computer-readable storage medium storing one or more programs configured to be executed by one or more processors of a computer system is described. In some examples, the one or more programs includes instructions for: receiving a first setup code for an accessory, wherein the accessory is different from the computer system; and in response to receiving the first setup code: in accordance with a determination that a setup component of the computer system has not previously established a credential with the accessory, sending, to the accessory, a request to add a first credential to grant one or more first entitlements with respect to the accessory, wherein the request to establish the first credential includes the first setup code; and in accordance with a determination that the setup component has previously established a credential with the accessory, sending, to the accessory, a request to add a second credential to grant one or more second entitlements with respect to the accessory, wherein the second credential is different from the first credential, and wherein the request to add the second credential includes a second setup code that is different from the first setup code.

In some examples, a transitory computer-readable storage medium storing one or more programs configured to be executed by one or more processors of a computer system is described. In some examples, the one or more programs includes instructions for: receiving a first setup code for an accessory, wherein the accessory is different from the computer system; and in response to receiving the first setup code: in accordance with a determination that a setup component of the computer system has not previously established a credential with the accessory, sending, to the accessory, a request to add a first credential to grant one or more first entitlements with respect to the accessory, wherein the request to establish the first credential includes the first setup code; and in accordance with a determination that the setup component has previously established a credential with the accessory, sending, to the accessory, a request to add a second credential to grant one or more second entitlements with respect to the accessory, wherein the second credential is different from the first credential, and wherein the request to add the second credential includes a second setup code that is different from the first setup code.

In some examples, a computer system is described. In some examples, the computer system comprises one or more processors and memory storing one or more program configured to be executed by the one or more processors. In some examples, the one or more programs includes instructions for: receiving a first setup code for an accessory, wherein the accessory is different from the computer system; and in response to receiving the first setup code: in accordance with a determination that a setup component of the computer system has not previously established a credential with the accessory, sending, to the accessory, a request to add a first credential to grant one or more first entitlements with respect to the accessory, wherein the request to establish the first credential includes the first setup code; and in accordance with a determination that the setup component has previously established a credential with the accessory, sending, to the accessory, a request to add a second credential to grant one or more second entitlements with respect to the accessory, wherein the second credential is different from the first credential, and wherein the request to add the second credential includes a second setup code that is different from the first setup code.

In some examples, a computer system is described. In some examples, the computer system comprises means for performing each of the following steps: receiving a first setup code for an accessory, wherein the accessory is different from the computer system; and in response to receiving the first setup code: in accordance with a determination that a setup component of the computer system has not previously established a credential with the accessory, sending, to the accessory, a request to add a first credential to grant one or more first entitlements with respect to the accessory, wherein the request to establish the first credential includes the first setup code; and in accordance with a determination that the setup component has previously established a credential with the accessory, sending, to the accessory, a request to add a second credential to grant one or more second entitlements with respect to the accessory, wherein the second credential is different from the first credential, and wherein the request to add the second credential includes a second setup code that is different from the first setup code.

In some examples, a computer program product is described. In some examples, the computer program product comprises one or more programs configured to be executed by one or more processors of a computer system. In some examples, the one or more programs include instructions for: receiving a first setup code for an accessory, wherein the accessory is different from the computer system; and in response to receiving the first setup code: in accordance with a determination that a setup component of the computer system has not previously established a credential with the accessory, sending, to the accessory, a request to add a first credential to grant one or more first entitlements with respect to the accessory, wherein the request to establish the first credential includes the first setup code; and in accordance with a determination that the setup component has previously established a credential with the accessory, sending, to the accessory, a request to add a second credential to grant one or more second entitlements with respect to the accessory, wherein the second credential is different from the first credential, and wherein the request to add the second credential includes a second setup code that is different from the first setup code.

### DESCRIPTION OF THE FIGURES

Fora better understanding of the various described embodiments, reference should be made to the Detailed Description below, in conjunction with the following drawings in which like reference numerals refer to corresponding pails throughout the figures.

FIG. 1 is a block diagram illustrating a compute system.

FIG. 2 is a block diagram illustrating a device with interconnected subsystems.

FIG. 3 is a block diagram illustrating a controller communicating with multiple accessories.

FIG. 4 is a flow diagram illustrating a method for setting tip an accessory in accordance with some embodiments.

### DETAILED DESCRIPTION

The following description sets forth exemplary techniques, methods, parameters, systems, computer-readable storage mediums, and the like. It should be recognized, however, that such description is not intended as a limitation on the scope of the present disclosure. Instead, such description is provided as a description of exemplary embodiments.

Methods described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a method until all of the conditions upon which steps in the method are contingent have been satisfied. A person having ordinary skill in the art would also understand that, similar to a method with contingent steps, a system or computer readable storage medium can repeat the steps of a method as many times as needed to ensure that all of the contingent steps have been performed.

Although the following description uses terms “first,” “second,” etc. to describe various elements, these elements should not be limited by the terms. In some examples, these terms are used to distinguish one element from another. For example, a first subsystem could be termed a second subsystem, and, similarly, a subsystem device could be termed a subsystem device, without departing from the scope of the various described embodiments. In some examples, the first subsystem and the second subsystem are two separate references to the same subsystem. In some embodiments, the first subsystem and the second subsystem are both subsystem, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

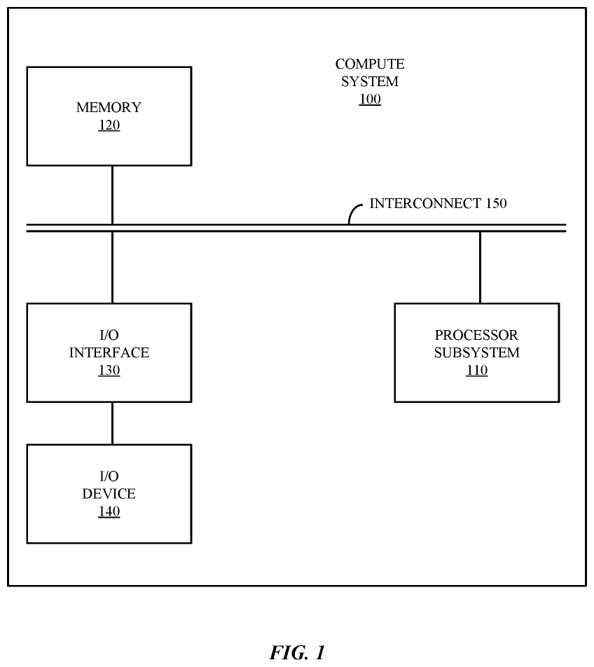

Turning to FIG. 1, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some examples, I/O interface 130 is included with I/O device 140 such that the two are a single component. It should be recognized that there can be one or more I/O interfaces, with each I/O interface communicating with one or more U/O devices. In some examples, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some examples, compute system 100 is included or communicating with a physical component for the purpose of modifying the physical component in response to an instruction. In some examples, compute system 100 receives an instruction to modify a physical component and, in response to the instruction, causes the physical component to be modified. In some examples, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some examples, a sensor includes one or more hardware components that detect information about a physical environment in proximity to (e.g., surrounding) the sensor. In some examples, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some examples, a sensor includes a combination of multiple sensors. In some examples, sensor data is captured by fusing data from one sensor with data from one or more other sensors. Although a single compute system is shown in FIG. 1, compute system 100 can also be implemented as two or more compute systems operating together.

In some examples, processor subsystem 110 includes one or more processors or processing units configured to execute program instructions to perform functionality described herein. For example, processor subsystem 110 can execute an operating system, a middleware system, one or more applications, or any combination thereof.

In some examples, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive eXecutive (AIX), network operating systems (e.g., Microsoft Windows Server), and real-time operating systems (e.g. QNX). In some examples, the operating system includes various procedures, sets of instructions, software components, and/or drivers for controlling and managing general system tasks (e.g., memory management, storage device control, power management, or the like) and for facilitating communication between various hardware and software components. In some examples, the operating system uses a priority-based scheduler that assigns a priority to different tasks that processor subsystem 110 can execute. In such examples, the priority assigned to a task is used to identify a next task to execute. In some examples, the priority-based scheduler identifies a next task to execute when a previous task finishes executing. In some examples, the highest priority task runs to completion unless another higher priority task is made ready.

In some examples, the middleware system provides one or more services and/or capabilities to applications (e.g., the one or more applications running on processor subsystem 110) outside of what the operating system offers (e.g., data management, application services, messaging, authentication, API management, or the like). In some examples, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some examples, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some examples, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some examples, the first node notifies the second node that the data has been stored in the memory by sending a pointer (e.g., a memory pointer, such as an identification of a memory location) to the second node so that the second node can access the data from where the first node stored the data. In some examples, the first node would send the data directly to the second node so that the second node would not need to access a memory based on data received from the first node.

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with methods 800, 900, 1000, 11000, 12000, 1300, 1400, and 1500 described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some examples, these other forms of storage can also store program instructions executable by processor subsystem 110 to perform operations described herein. In some examples, processor subsystem 110 (or each processor within processor subsystem 110) contains a cache or other form of on-board memory.

I/O interface 130 can be any of various types of interfaces configured to communicate with other devices. In some examples, I/O interface 130 includes abridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some examples, compute system 100 is communicating with a network via a network interface device (e.g., configured to communicate over Wi-Fi, Bluetooth, Ethernet, or the like). In some examples, compute system 100 is directly or wired to the network.

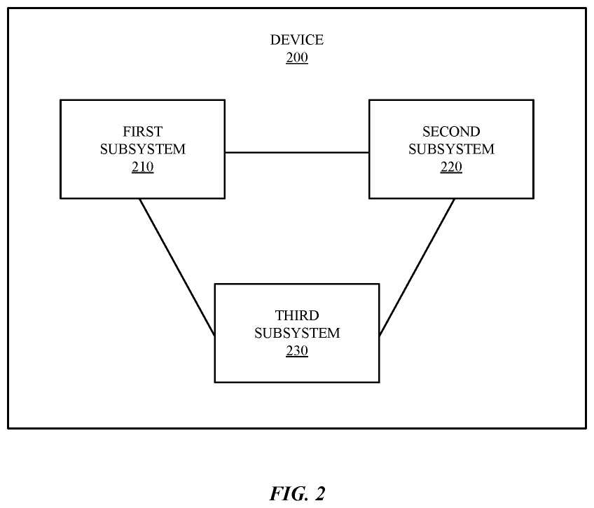

FIG. 2 illustrates a block diagram of device 200 with interconnected subsystems. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1 (i.e., compute system 100). Although three subsystems are shown in FIG. 2, device 200 can include more or fewer subsystems.

In some examples, some subsystems are not connected to other subsystem (e.g., first subsystem 210 can be connected to second subsystem 220 and third subsystem 230 but second subsystem 220 cannot be connected to third subsystem 230). In some examples, some subsystems are connected via one or more wires while other subsystems are wirelessly connected. In some examples, messages are set between the first subsystem 210, second subsystem 220, and third subsystem 230, such that when a respective subsystem sends a message the other subsystems receive the message (e.g., via a wire and/or a bus). In some examples, one or more subsystems are wirelessly connected to one or more compute systems outside of device 200, such as a server system. In such examples, the subsystem can be configured to communicate wirelessly to the one or more compute systems outside of device 200.

In some examples, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some examples, device 200 is configured to navigate (with or without user input) in a physical environment.

In some examples, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some examples, at least a portion of device 200 functions as a distributed compute system. For example, a task can be split into different portions, where a first portion is executed by first subsystem 210 and a second portion is executed by second subsystem 220.

Attention is now directed towards techniques for setting up electronic devices. Such techniques are described in the context of applications of a controller connecting with accessories. It should be recognized that other types of electronic devices can be used with techniques described herein. For example, an accessory can connect with another accessory using techniques described herein. In addition, techniques optionally complement or replace other techniques for connecting devices.

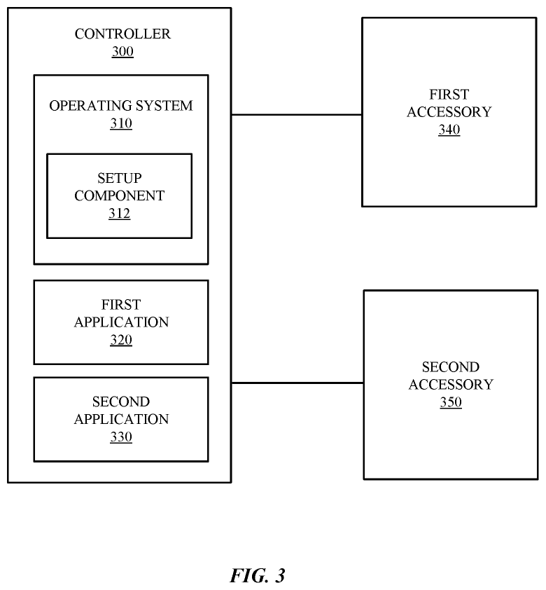

FIG. 3 is a block diagram illustrating a controller (e.g., controller 300) communicating with multiple accessories (e.g., first accessory 340 and second accessory 350). Controller 300 is a non-limiting example of a controller that can be used to perform the functionality described herein. It should be recognized that other computer architecture of a controller can be used to perform the functionality described herein. In some examples, controller 300 includes one or more features described above in relation to compute system 100 and/or device 200. In some examples, controller 300 is compute system 100 and/or device 200. In some examples, one or more features described in relation to controller 300 can be combined, substituted, and/or replaced with one or more features described in relation to compute system 100 and/or device 200. In some examples, controller 300 is a mobile device, a personal computing device, a multi-user speaker (e.g., including a microphone), a single-user speaker (e.g., including a microphone), a fitness tracking device (e.g., a smart watch and/or a heart rate monitor), and/or a head-mounted display device.

As illustrated in FIG. 3, controller 300 includes operating system 310, first application 320, and second application 330. In other words, operating system 310, first application 320, and second application 330 are installed on controller 300. In some examples, first application 320 and/or second application 330 are in communication with but not installed on controller 300 (e.g., first application 320 and/or second application 330 are installed on a remote device that is communicating with controller 300). In some examples, operating system 310 manages resources of controller 300 and can be one or more operating systems as discussed above in relation to the operating system of compute system 100. For example, operating system 310 can be LINUX, iOS, or Windows operating system. In some examples, operating system 310 is an operating system for a mobile device, such as an operating system fora tablet and/or a mobile phone. In some examples, operating system 310 includes one or more operations to control a graphical user interface.

As illustrated in FIG. 3, operating system 310 includes setup component 312. Setup component 312 is configured to communicate with one or more different accessories, such as first accessory 340 and second accessory 350. In some examples, setup component 312 can configure an accessory to communicate with setup component 312 and/or another software component of the controller 300, such as first application 320 or second application 330. In some examples, all or most communications between controller 310 and an accessory are routed through setup component 312. In some examples, that first application 320 and second application 330 do not directly communicate with the accessory but, instead, send communications to setup component 312 so that setup component 312 communicates with the accessory on behalf of first application 320 and second application. In some examples, setup component 312 includes one or more instructions for performing one or more setup operations. In some examples, the one or more setup operations include operations that are performed (or that allow) for an accessory to be configured to communicate with controller 300 (e.g., a particular application of controller 300 or generally to controller 400), one or more other controllers, and/or one or more computer systems (e.g., having one or more features of compute system 100 and/or device 200). In some examples, setup component 312 includes operations for sending and/or receiving data for registering and/or controlling an accessory, such as first accessory 340 and second accessory 350. In some examples, setup component 312 is an application that is separate from operating system 310. In some examples, one or more of first application 320 and second application 330 are a part of operating system 310, irrespective of whether setup component 312 is a part of operating system 310. In some examples, the controller includes one or more applications other than first application 320 and second application 330.

As illustrated in FIG. 3, first application 320 and second application 330 are different applications. In some examples, first application 320 and second application 330 correspond to different ecosystems. Examples of an ecosystem include a smart home ecosystem, a smart office ecosystem, a smart manufacturing ecosystem, and/or a smart company ecosystem. In some examples, one or more accessories can be registered with (and/or controlled within) an ecosystem. Thus, in some examples, first application 320 and second application 330 are configured to communicate with one or more accessories. In some examples, the one or more accessories with which first application 320 is configured to communicate are different from the one or more accessories with which second application 330 is configured to communicate. In some examples, first application 320 and second application 330 communicates with an accessory by sending one or more commands (e.g., instructions and/or requests to control) to change a state of an accessory and/or receive information about a state of the accessory. In some examples, changing a state of an accessory includes changing a setting for the accessory, turning the setting off, and/or turning the setting on. In some examples, when a respective application is configured to communicate with an accessory, the respective application receives data concerning the state of the accessory, such as a value (e.g., brightness value of a light, temperature value of a thermostat, remaining battery value, overheating value, and/or fan speed of a ceiling fan) associated with the accessory or whether the accessory is on or off. In some examples, the respective application receives historical data concerning the accessory. It should be understood that first application 320 and second application 330 can be other types of applications, such as an application corresponding to a specific type of accessory and/or manufacturer (e.g., an application for controlling a light bulb), an application corresponding to multiple different ecosystems (e.g., an application corresponding to multiple different smart home ecosystems including, the Apple Home and the Google Home), and/or any other type of application (e.g., a map application, a music application, and/or a communication application).

In some examples, communications between setup component 312 and an application (e.g., first application 320 and/or second application 330) are communications within a single computer system while communications between one or more components of controller 300 (e.g., operating system 310, setup component 312, first application 320, and/or second application 330) and first accessory 340 and second accessory 350 are communications between different computer systems.

Such communications between different computer systems can be wired communication and/or wireless communication. In some examples, setup component 312 (or another component of controller 300) communicates with first accessory 340 through a communication method, such as Bluetooth, Zigbee, near-field communication, WiFi, LiFi, 5G, or any other wireless communication technology. In some examples, setup component 312 (or another component of controller 300) communicates with first accessory 340 via one communication method and communicates with second accessory 350 via another communication method.

At FIG. 3, first accessory 340 and second accessory 350 are different types of accessories. Examples of an accessory include an air conditioner, an air purifier, a bridge, a camera, a doorbell, a fan, a faucet, a garage door, a humidifier, a light, a lock, an outlet, a receiver, a router, a security system, a sensor, a speaker, a sprinkler, a switch, a thermostat, a television, and/or a window. In some examples, first accessory 340 and/or second accessory 350 is a computer system that operates autonomously and/or in response to user input. In some examples, first accessory 340 and/or second accessory 350 autonomously performs one or more operations that are scheduled by a user over intervals of time, performs one or more operations that are performed due to one or more conditions being met (e.g., a threshold level of light and/or a threshold level of sound in the environment), and/or performs one or more operations that are performed in response to user input. In some of these examples, the user input is directed to the physical accessory or an application that is configured to control the accessory, such as first application 320, second application 330, and/or another application. In some examples, the controller is in communication with one or more accessories other than or in addition to first accessory 340 and second accessory 350.

As discussed above, computer systems (e.g., controllers, accessories, and/or other electronic devices) communicate with (e.g., send and/or receive communications to/from) an accessory (e.g., first accessory 340 or second accessory 350). Traditionally, the accessory requires a computer system to register with the accessory to ensure that only particular electronic devices can communicate with the accessory. An example of such registration includes the computer system sending a secret (e.g., a setup code corresponding to/known by the accessory, such as one or more alphanumeric characters) to the accessory with other information to identify the computer system. The accessory then stores the other information to identify the computer system when sending and/or receiving communications. Such other information is sometimes referred to as a credential and offers a secure way for communication. In some examples, the secret is used to establish a mutually authenticated bidirectional secure channel between the computer system and the accessory. Over the secure channel, the other information is installed. In some examples, the computer system uses the other information to create secure sessions for other (e.g., further and/or future) communication with the accessory.

In some examples, accessories limit the number of times that a particular secret can be used to register with the accessory. For example, an accessory can only allow a particular secret to be used one time and any subsequent registration would need to be through the previous registration (e.g., generating a new secret that is provided to the accessory using the previous registration) or by resetting the accessory. Such limits make configuring accessories difficult, particularly when a user wishes to have more complex configurations. For example, a user can have a computer system (referred to as a controller) that includes different applications that the user wants to each be individually configured to communicate with the accessory. The different applications would therefore need to be separately registered with the accessory using different secrets and, optionally, have different entitlements with respect to the accessory. Such different registrations are sometimes referred to as different ecosystems due at least partially to the fact that such registrations are kept separate by the accessory.

In some examples, techniques described herein help mitigate the problem that secrets can only be used once. For example, an accessory can include a QR code. The QR code can be scanned by a controller to determine a secret corresponding to the QR code. The controller can then use the secret to add the accessory to an ecosystem corresponding to a first application of the controller. At a later point in time, the controller can again scan the QR code to determine the secret corresponding to the QR code. At this time, the controller can attempt to add the accessory to a different ecosystem than before, the different ecosystem corresponding to a second application of the controller. Traditionally, such behavior would not be allowed because the QR code and corresponding secret can only be used to add the accessory to a single ecosystem (e.g., the secret needs to uniquely link to a particular relationship). The user would then need to either go through the first application to add the accessory or restart the accessory. However, to provide a better user experience, a setup component of the controller can determine that the QR code and/or corresponding secret has been previously used to add the accessory to an ecosystem (as described in more detail below) and, instead of using the secret, can generate (e.g., without user involvement) a new secret that is then used to add the accessory to the different ecosystem. The new secret would then be different from the secret and would maintain the requirement that a secret uniquely links to a particular relationship (e.g., the secret links to the ecosystem corresponding to the first application and the new secret links to the different ecosystem corresponding to the second application).

Using the techniques described above, setup component 312 of controller 300 receives a first setup code for the accessory. In some examples, setup component 312 receives the first set up code in response to receiving an indication to connect an application with the accessory. In some examples, the indication to connect is received from the accessory (e.g., first accessory 340 and/or second accessory 350). In some examples, the indication to connect is received from the application (e.g., first application 320 and/or second application 330).

The setup component 312 can receive the first setup code in different ways. In some examples, setup component 312 receives the setup code through user input, such as a user typing or otherwise manually entering the setup code. In other examples, setup component 312 receives the setup code via one or more cameras that are in communication with controller 312 capturing an image corresponding to (e.g., containing or linking to) the first setup code. In such examples, the image can include a QR code that is representative of the setup code. In other examples, the image can include a pattern of light output by the accessory In some examples, setup component 312 receives the first setup code when data corresponding to the first setup code is transferred via a device (e.g., first accessory 340, second accessory 350, or another device). For example, the device can include a near-field communication (NFC) tag that sends the setup code to setup component 312 when controller 300 is nearby the device. For another example, the device can include a radio using one or more different wireless technologies (e.g., Bluetooth, WiFi, or broadcast radio). In some examples, the wireless technology used is a short-range wireless technology to ensure proximity to the device.

In some examples, in response to receiving the first setup code for the accessory, a determination is made concerning whether a credential corresponding to the first setup code has been added to the accessory. The determination of whether the credential corresponding to the first setup code has been added to the accessory can be performed in different ways. In some examples, as a part of determining whether the credential corresponding to the first setup code has been added to the accessory, setup component 312 performs a search in a look-up table that contains a list of accessories (e.g., and optionally credentials) and determines that the accessory (or credential corresponding to the first setup code) is included in the list. In other examples, as a part of determining whether the credential corresponding to the first setup code has been added to the accessory, setup component 312 sends a request to the accessory to determine whether the accessory has a credential corresponding to the first setup code and determines that the credential corresponding to the first setup code has been added to the accessory based on a response from the accessory to the request. In further examples, as a part of determining whether the credential corresponding to the first setup code has been added to the accessory, setup component 312 sends one or more requests to one or more other devices and/or applications (e.g., first application 320 or second application 330) to determine whether the accessory has a credential corresponding to the first setup code and determines that the credential corresponding to the first setup code has been added to the accessory based on one or more responses from the one or more devices and/or applications to the one or more requests.

In some examples, if a determination is made that a credential corresponding to the first setup code has not been added to the accessory, setup component 312 sends a first request to the accessory to add a credential, where the request includes the first setup code.

In some examples, if a determination is made that a credential corresponding to the first setup code has been added to the accessory, setup component 312 sends a different request to the accessory to add a credential, where the different request includes a second setup code that is not the same as the first setup code. Thus, in some examples, setup component 312 (1) sends a different setup code from the first setup code when the credential corresponding to the first setup code has been added and (2) sends the first setup code when the credential corresponding to the first setup code has not been added. In some examples, sending the request to the accessory causes first application 320 or second application 330 to be registered (e.g., sometimes referred to as paired) with the accessory.

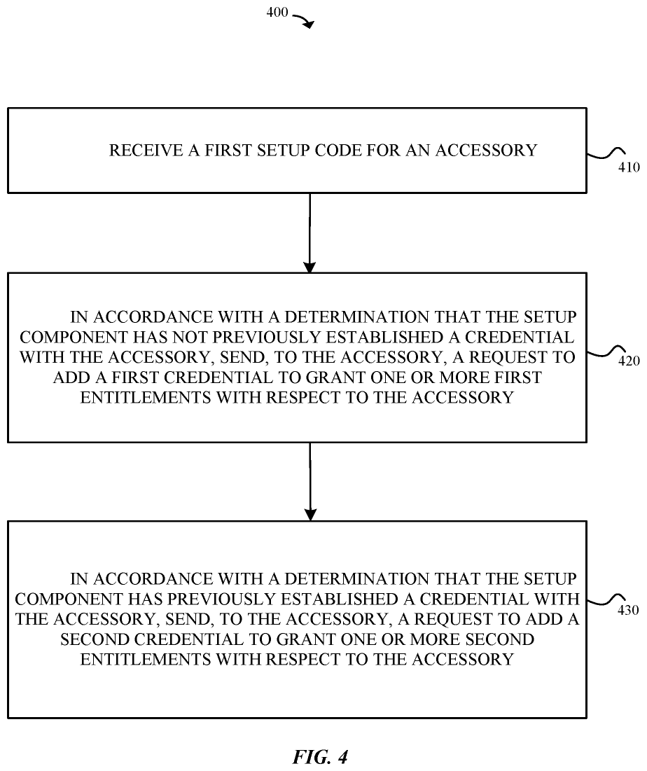

FIG. 4 is a flow diagram illustrating a method for setting up an accessory in accordance with some embodiments. Method 400 is performed at a setup component (e.g., 312) (e.g., an operating-system component or an application different from an operating system) of a computer system (e.g., 100, 200, and/or 300). In some examples, the computer system is a watch, a phone, a tablet, a processor, a head-mounted display (HMD) device, and/or a personal computing device.

The setup component receives (410) a first setup code for an accessory, where the accessory is different from the computer system. In some examples, the accessory is an air conditioner, an air purifier, a bridge, a camera, a doorbell, a fan, a faucet, a garage door, a humidifier, a light, a lock, an outlet, a receiver, a router, a security system, a sensor, a speaker, a sprinkler, a switch, a thermostat, a television, an actuator, and/or a window. In some examples, the first setup code is a set of one or more alphanumerical characters.

In response to receiving the first setup code and in accordance with a determination that the setup component has not previously established a credential with the accessory (e.g., has not been previously registered/paired with and/or a credential has not been previously installed for), the setup component sends (420), to the accessory, a request to add a first credential to grant one or more first entitlements (e.g., one or more rights, permissions, and/or abilities) (e.g., establish a first ecosystem and/or manage the one or more accessories) with respect to the accessory (e.g., add a controller, an ecosystem, a credential to control the accessory, and/or an administrator different from the setup component), where the request to establish the first credential includes the first setup code. In some examples, the first ecosystem is a grouping of one or more accessories and one or more controllers (e.g., a device, a computer system, an application executing on a device, and/or a software process configured to control an accessory).

In response to receiving the first setup code and in accordance with a determination that the setup component has previously established a credential with the accessory, the setup component sends (430), to the accessory, a request to add a second credential to grant one or more second entitlements (e.g., the one or more second entitlements are the same as the one or more first entitlements or are different from the one or more first entitlements (e.g., at least one different entitlement of the one or more first entitlements)) with respect to the accessory, where the second credential is different from the first credential, and where the request to add the second credential includes a second setup code that is different (e.g., a different value) from the first setup code (e.g., the second setup code includes a set of one or more alphanumerical characters and the first setup code includes a different set of one or more alphanumerical characters) (e.g., the second setup code includes values for a set of one or more bits and the first setup code includes different values for a set of one or more corresponding bits).

In some examples, the first setup code is determined from an image (e.g., an image of a pattern (e.g., a QR code or a light) corresponding to the accessory) captured by a camera in communication with the computer system (e.g., a camera of the computer system); or the first setup code is received, via a communication channel, from a device different from the computer system. In some examples, the communication channel is Bluetooth, WiFi, an internet protocol communication channel, NFC, or UWB.

In some examples, after sending the request to add the first credential, the setup component receives a third setup code for the accessory. In some examples, the third setup code is the same as the first setup code. In some examples, the third setup code is obtained via the same process as the first setup code (e.g., if the first setup code is determined from an image, the third setup code is determined from an image) (e.g., if the first setup code is received via a communication channel of a particular type, the third setup code is received via a communication channel of the particular type). In some examples, in response to receiving the third setup code, the setup component sends, to the accessory, a request to add a third credential to grant the one or more second entitlements with respect to the accessory. In some examples, the request to add the third credential includes a fourth setup code that is different (e.g., a different value) from the third setup code (e.g., the fourth setup code includes a set of one or more characters and the third setup code includes a different set of one or more characters) (e.g., the fourth setup code includes values for a set of one or more bits and the third setup code includes different values for a set of one or more corresponding bits).

In some examples, after sending the request to add the first credential, the setup component sends, to the accessory using a particular credential (e.g., a credential established between the setup component and the accessory, the credential not corresponding to an application of the computer system) (e.g., a message sent to the accessory can include the first credential and/or an indication of the first credential), a request to add a fourth credential to grant a second application of the computer system one or more third entitlements (e.g., the one or more third entitlements are the same as the one or more first entitlements or are different from the one or more first entitlements (e.g., at least one different entitlement of the one or more first entitlements)) with respect to the accessory. In some examples, the request to add the first credential is sent using the particular credential (e.g., a message sent to the accessory can include the first credential and/or an indication of the first credential) to grant a first application of the computer system the one or more first entitlements with respect to the accessory. In some examples, the second application is different from the first application and the setup component. In some examples, the first application is different from the setup component. In some examples, the first application and/or the second application is an application of an ecosystem that allows for a user to control one or more accessories (including, for example, accessories of different types and/or from different manufacturers), an application of an accessory manufacturer that allows for a user to control one or more accessories associated with the accessory manufacturer, and/or an application for a particular communication protocol (e.g., the application communicates according to the particular communication protocol to accessories that are configured for the particular communication protocol). In some examples, the particular credential is different from the first, second, third, and fourth credential.

In some examples, the setup code is received from an application of the computer system. In some examples, the application is different from the setup component. In some examples, the application is an application of an ecosystem that allows for a user to control one or more accessories (including, for example, accessories of different types and/or from different manufacturers), an application of an accessory manufacturer that allows for a user to control one or more accessories associated with the accessory manufacturer, and/or an application for a particular communication protocol (e.g., the application communicates according to the particular communication protocol to accessories that are configured for the particular communication protocol).

In some examples, the setup component receives, from an application of the computer system, an indication of an ecosystem. In some examples, the application is an application of an ecosystem that allows for a user to control one or more accessories (including, for example, accessories of different types and/or from different manufacturers), an application of an accessory manufacturer that allows for a user to control one or more accessories associated with the accessory manufacturer, and/or an application for a particular communication protocol (e.g., the application communicates according to the particular communication protocol to accessories that are configured for the particular communication protocol). In some examples, the ecosystem is a grouping of one or more accessories and one or more controllers (e.g., a device, a computer system, an application executing on a device, and/or a software process configured to control an accessory). In some examples, in response to receiving the indication of the ecosystem: in accordance with a determination that the ecosystem has not previously established a credential with the accessory, the setup component sends, to the accessory, a request to add a credential; and in accordance with a determination that the ecosystem has previously established a credential with the accessory, the setup component forgoes sending, to the accessory, a request to add a credential.

In some examples, the first setup code includes one or more characters (e.g., alphanumeric characters, symbols, and/or text). In some examples, the second setup code includes one or more characters (e.g., alphanumeric characters, symbols, and/or text).

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve how a device interacts with a user. The present disclosure contemplates that in some instances, this gathered data can include personal information data that uniquely identifies or can be used to contact or locate a specific person. Such personal information data can include demographic data, location-based data, telephone numbers, email addresses, home addresses, or any other identifying information.

The present disclosure recognizes that the use of such personal information data, in the present technology, can be used to the benefit of users. For example, the personal information data can be used to change how a device interacts with a user. Accordingly, use of such personal information data enables better user interactions. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be displayed to users by inferring location based on non-personal information data or a bare minimum amount of personal information, such as the content being requested by the device associated with a user or other non-personal information.

What is claimed is:

1. A method, comprising:
at a setup component of a computer system:
receiving a first setup code for an accessory, wherein the accessory is different from the computer system; and
in response to receiving the first setup code:
in accordance with a determination that the setup component has not previously established a credential with the accessory, sending, to the accessory, a request to add a first credential to grant one or more first entitlements with respect to the accessory, wherein the request to establish the first credential includes the first setup code; and
in accordance with a determination that the setup component has previously established a credential with the accessory, sending, to the accessory, a request to add a second credential to grant one or more second entitlements with respect to the accessory, wherein the second credential is different from the first credential, and wherein the request to add the second credential includes a second setup code that is different from the first setup code.

2. The method of claim 1, wherein the first setup code is:
determined from an image captured by a camera in communication with the computer system; or
received, via a communication channel, from a device different from the computer system.

3. The method of claim 1, further comprising:
after sending the request to add the first credential, receiving a third setup code for the accessory, wherein the third setup code is the same as the first setup code, wherein the third setup code is obtained via the same process as the first setup code; and
in response to receiving the third setup code, sending, to the accessory, a request to add a third credential to grant the one or more second entitlements with respect to the accessory, wherein the request to add the third credential includes a fourth setup code that is different from the third setup code.

4. The method of claim 1, further comprising:
after sending the request to add the first credential, sending, to the accessory using a particular credential, a request to add a fourth credential to grant a second application of the computer system one or more third entitlements with respect to the accessory, wherein the request to add the first credential is sent using the particular credential to grant a first application of the computer system the one or more first entitlements with respect to the accessory, wherein the second application is different from the first application and the setup component, and wherein the first application is different from the setup component.

5. The method of claim 1, wherein the setup code is received from an application of the computer system, and wherein the application is different from the setup component.

6. The method of claim 1, further comprising:
receiving, from an application of the computer system, an indication of an ecosystem; and
in response to receiving the indication of the ecosystem:
in accordance with a determination that the ecosystem has not previously established a credential with the accessory, sending, to the accessory, a request to add a credential; and
in accordance with a determination that the ecosystem has previously established a credential with the accessory, forgoing sending, to the accessory, a request to add a credential.

7. The method of claim 1, wherein the first setup code includes one or more characters, and wherein the second setup code includes one or more characters.

8. A non-transitory computer-readable storage medium storing one or more programs configured to be executed by one or more processors of a computer system, the one or more programs including instructions for:
receiving a first setup code for an accessory, wherein the accessory is different from the computer system; and
in response to receiving the first setup code:
in accordance with a determination that a setup component of the computer system has not previously established a credential with the accessory, sending, to the accessory, a request to add a first credential to grant one or more first entitlements with respect to the accessory, wherein the request to establish the first credential includes the first setup code; and
in accordance with a determination that the setup component has previously established a credential with the accessory, sending, to the accessory, a request to add a second credential to grant one or more second entitlements with respect to the accessory, wherein the second credential is different from the first credential, and wherein the request to add the second credential includes a second setup code that is different from the first setup code.

9. The non-transitory computer-readable storage medium of claim 8, wherein the first setup code is:
determined from an image captured by a camera in communication with the computer system; or
received, via a communication channel, from a device different from the computer system.

10. The non-transitory computer-readable storage medium of claim 8, wherein the one or more programs include instructions for:
after sending the request to add the first credential, receiving a third setup code for the accessory, wherein the third setup code is the same as the first setup code, wherein the third setup code is obtained via the same process as the first setup code; and
in response to receiving the third setup code, sending, to the accessory, a request to add a third credential to grant the one or more second entitlements with respect to the accessory, wherein the request to add the third credential includes a fourth setup code that is different from the third setup code.

11. The non-transitory computer-readable storage medium of claim 8, wherein the one or more programs include instructions for:
after sending the request to add the first credential, sending, to the accessory using a particular credential, a request to add a fourth credential to grant a second application of the computer system one or more third entitlements with respect to the accessory, wherein the request to add the first credential is sent using the particular credential to grant a first application of the computer system the one or more first entitlements with respect to the accessory, wherein the second application is different from the first application and the setup component, and wherein the first application is different from the setup component.

12. The non-transitory computer-readable storage medium of claim 8, wherein the setup code is received from an application of the computer system, and wherein the application is different from the setup component.

13. The non-transitory computer-readable storage medium of claim 8, wherein the one or more programs include instructions for:
receiving, from an application of the computer system, an indication of an ecosystem; and
in response to receiving the indication of the ecosystem:
in accordance with a determination that the ecosystem has not previously established a credential with the accessory, sending, to the accessory, a request to add a credential; and
in accordance with a determination that the ecosystem has previously established a credential with the accessory, forgoing sending, to the accessory, a request to add a credential.

14. The non-transitory computer-readable storage medium of claim 8, wherein the first setup code includes one or more characters, and wherein the second setup code includes one or more characters.

15. A computer system, comprising:
one or more processors; and
memory storing one or more programs configured to be executed by the one or more processors, the one or more programs including instructions for:
receiving a first setup code for an accessory, wherein the accessory is different from the computer system; and
in response to receiving the first setup code:
in accordance with a determination that a setup component of the computer system has not previously established a credential with the accessory, sending, to the accessory, a request to add a first credential to grant one or more first entitlements with respect to the accessory, wherein the request to establish the first credential includes the first setup code; and
in accordance with a determination that the setup component has previously established a credential with the accessory, sending, to the accessory, a request to add a second credential to grant one or more second entitlements with respect to the accessory, wherein the second credential is different from the first credential, and wherein the request to add the second credential includes a second setup code that is different from the first setup code.

16. The computer system of claim 15, wherein the first setup code is:
determined from an image captured by a camera in communication with the computer system; or
received, via a communication channel, from a device different from the computer system.

17. The computer system of claim 15, wherein the one or more programs include instructions for:
after sending the request to add the first credential, receiving a third setup code for the accessory, wherein the third setup code is the same as the first setup code, wherein the third setup code is obtained via the same process as the first setup code; and
in response to receiving the third setup code, sending, to the accessory, a request to add a third credential to grant the one or more second entitlements with respect to the accessory, wherein the request to add the third credential includes a fourth setup code that is different from the third setup code.

18. The computer system of claim 15, wherein the one or more programs include instructions for:
after sending the request to add the first credential, sending, to the accessory using a particular credential, a request to add a fourth credential to grant a second application of the computer system one or more third entitlements with respect to the accessory, wherein the request to add the first credential is sent using the particular credential to grant a first application of the computer system the one or more first entitlements with respect to the accessory, wherein the second application is different from the first application and the setup component, and wherein the first application is different from the setup component.

19. The computer system of claim 15, wherein the setup code is received from an application of the computer system, and wherein the application is different from the setup component.

20. The computer system of claim 15, wherein the one or more programs include instructions for:
receiving, from an application of the computer system, an indication of an ecosystem; and
in response to receiving the indication of the ecosystem:
in accordance with a determination that the ecosystem has not previously established a credential with the accessory, sending, to the accessory, a request to add a credential; and
in accordance with a determination that the ecosystem has previously established a credential with the accessory, forgoing sending, to the accessory, a request to add a credential.
